(19) United States
(12) Patent Application Publication
(10) Pub. No.: US 2026/0082140 A1
(43) Pub. Date: Mar. 19, 2026

(54) OPTICAL INTERLEAVED ANALOG IMAGE STREAMING

(71) Applicant: University of Central Florida Research Foundation, Inc., Orlando, FL (US)

(72) Inventor: Shuo Pang, Oviedo, FL (US)

(21) Appl. No.: 19/169,813

(22) Filed: Apr. 3, 2025

Related U.S. Application Data
(60) Provisional application No. 63/695,190, filed on Sep. 16, 2024.

(51) Int. Cl. H04N 25/78; H04N 25/77

(52) U.S. Cl. CPC H04N 25/78; H04N 25/77

(57) ABSTRACT

The present disclosure may provide an imaging system and method for interleaved analog imaging. The system can include one or more photodetector arrays providing analog electrical signals, and may comprise an analog photonic interleaver. The interleaver can include photonic modulators that may be configured to convert the analog electrical signals to analog optical signals, and may comprise photonic multiplexers that can be configured to interleave the analog optical signals into an optical interleaved signal. The method may include providing analog electrical signals from photodetector arrays, can include converting the signals to analog optical signals using photonic modulators, and may comprise interleaving the optical signals into an optical interleaved signal. The system and method can enable high-speed imaging with potentially reduced latency and increased throughput, suitable for applications that may require continuous video acquisition and real-time processing.

### CROSS-REFERENCE TO RELATED APPLICATIONS

This application claims priority to U.S. Application No. 63/695,190, titled OPTICAL INTERLEAVED ANALOG IMAGE STREAMING, filed Sep. 16, 2024, which is hereby incorporated by reference in its entirety.

### TECHNICAL FIELD

The present disclosure relates to high-speed imaging systems, and more particularly to an optical interleaved analog imaging system for converting and multiplexing analog electrical image signals into high-speed analog optical data signals.

### BACKGROUND

High-speed imaging systems are utilized in various applications, including defense, scientific research, and industrial processes. These systems aim to capture rapid events or phenomena that occur too quickly for conventional cameras to record effectively. However, existing high-speed imaging technologies face limitations in continuous operation and data processing capabilities.

Current high-speed cameras often operate in burst mode, capturing a limited number of frames before filling their internal storage. This constraint restricts the duration of continuous high-speed imaging, typically to less than 30 seconds. Additionally, the readout, transfer, and processing of large volumes of image data introduce latency, which can be problematic for time-critical applications. The mismatch between high imaging throughput and slower data transfer, processing or storage capabilities creates bottlenecks in the imaging pipeline. There is therefore a need to develop systems and methods to address the above deficiencies.

### SUMMARY

In embodiments, the techniques described herein relate to an imaging system including one or more photodetector arrays providing a plurality of analog electrical signals; and an analog photonic interleaver including one or more photonic modulators configured to convert the plurality of analog electrical signals to analog optical signals; and one or more photonic multiplexers configured to interleave the analog optical signals from the one or more photonic modulators into an optical interleaved signal.

In embodiments, the techniques described herein relate to an imaging system, where the one or more photodetector arrays include a focal plane array.

In embodiments, the techniques described herein relate to an imaging system, where the one or more photonic modulators include at least one of micro-ring or micro-disk modulators.

In embodiments, the techniques described herein relate to an imaging system, where the at least one of micro-ring or micro-disk modulators are arranged in a push-pull interferometer configuration.

In embodiments, the techniques described herein relate to an imaging system, where the one or more photonic multiplexers are configured to perform time-division multiplexing.

In embodiments, the techniques described herein relate to an imaging system, where the one or more photonic multiplexers are configured to perform wavelength-division multiplexing.

In embodiments, the techniques described herein relate to an imaging system, where the one or more photonic multiplexers are configured to perform polarization-division multiplexing.

In embodiments, the techniques described herein relate to an imaging system, where the one or more photonic multiplexers are configured to perform mode-division multiplexing.

In embodiments, the techniques described herein relate to an imaging system, further including an optical source configured to provide source light to the one or more photonic modulators.

In embodiments, the techniques described herein relate to an imaging system, where the optical source includes a wavelength-multiplexed laser source.

In embodiments, the techniques described herein relate to an imaging system, further including a controller configured to coordinate operation of the one or more photodetector arrays and the analog photonic interleaver.

In embodiments, the techniques described herein relate to an imaging system, where the controller is configured to sequentially trigger non-overlapping exposure windows for the one or more photodetector arrays.

In embodiments, the techniques described herein relate to an imaging system, further including an electronic signal conditioning circuit configured to condition the plurality of analog electrical signals before they are provided to the one or more photonic modulators.

In embodiments, the techniques described herein relate to an imaging system, where the electronic signal conditioning circuit includes amplifiers configured to control amplitudes of the plurality of analog electrical signals.

In embodiments, the techniques described herein relate to an imaging system, further including a photonic switch configured to distribute source light to the one or more photonic modulators.

In embodiments, the techniques described herein relate to an imaging system, where the photonic switch includes at least one of micro-ring resonators or micro-disk resonators arranged in series.

In embodiments, the techniques described herein relate to an imaging system, further including a photodetector configured to convert the optical interleaved signal into an electrical interleaved signal.

In embodiments, the techniques described herein relate to an imaging system, further including a photonic processor configured to perform one or more image processing operations on the optical interleaved signal.

In embodiments, the techniques described herein relate to an imaging system, where the one or more photodetector arrays, the one or more photonic modulators, and the one or more photonic multiplexers are integrated on a single microchip.

In embodiments, the techniques described herein relate to an imaging system, where the one or more photodetector arrays are on a first microchip and the analog photonic interleaver is on a second microchip.

In embodiments, the techniques described herein relate to an imaging system, further including an analog-to-digital converter configured to digitize the optical interleaved signal.

In embodiments, the techniques described herein relate to an imaging system, further including a phase-locked loop configured to synchronize a clock for the analog photonic interleaver and the one or more photodetector arrays.

In embodiments, the techniques described herein relate to a method of interleaved analog imaging, including providing a plurality of analog electrical signals from one or more photodetector arrays; converting the plurality of analog electrical signals to analog optical signals using one or more photonic modulators; and interleaving the analog optical signals from the one or more photonic modulators into an optical interleaved signal using one or more photonic multiplexers.

In embodiments, the techniques described herein relate to a method, where interleaving the analog optical signals includes performing at least one of time-division multiplexing, wavelength-division multiplexing, polarization-division multiplexing, or mode-division multiplexing.

In embodiments, the techniques described herein relate to a method, further including coordinating operation of the one or more photodetector arrays and the analog photonic interleaver using a controller.

In embodiments, the techniques described herein relate to a method, further including conditioning the plurality of analog electrical signals before converting them to analog optical signals.

In embodiments, the techniques described herein relate to a method, where conditioning the plurality of analog electrical signals includes controlling amplitudes of the plurality of analog electrical signals using amplifiers.

In embodiments, the techniques described herein relate to a method, further including distributing source light to the one or more photonic modulators using a photonic switch.

In embodiments, the techniques described herein relate to a method, further including converting the optical interleaved signal into an electrical interleaved signal using a photodetector.

In embodiments, the techniques described herein relate to a method, further including performing one or more image processing operations on the optical interleaved signal using a photonic processor.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF FIGURES

The numerous advantages of the disclosure may be better understood by those skilled in the art by reference to the accompanying figures.

FIG. 1 illustrates a block diagram of an interleaved analog imaging system, in accordance with one or more embodiments of the present disclosure.

FIG. 2A shows a block diagram of photonic modulators converting analog electrical signals to analog optical signals, in accordance with one or more embodiments of the present disclosure.

FIG. 2B depicts a block diagram of an interleaved analog imaging system with an optical source, in accordance with one or more embodiments of the present disclosure.

FIG. 2C presents a schematic of photonic modulators with micro-ring resonators, in accordance with one or more embodiments of the present disclosure.

FIG. 2D illustrates a block diagram of an interleaved analog imaging system with a photonic switch, in accordance with one or more embodiments of the present disclosure.

FIG. 2E shows a simplified schematic of a photonic switch with micro-ring resonators, in accordance with one or more embodiments of the present disclosure.

FIG. 2F depicts a simplified schematic of a photonic switch in a fanout configuration, in accordance with one or more embodiments of the present disclosure.

FIG. 3A illustrates a block diagram of a photonic multiplexer, in accordance with one or more embodiments of the present disclosure.

FIG. 3B shows a schematic of a photonic multiplexer providing temporal multiplexing, in accordance with one or more embodiments of the present disclosure.

FIG. 4 depicts a schematic diagram of an interleaved optical imaging system with time-domain multiplexing, in accordance with one or more embodiments of the present disclosure.

FIG. 5A illustrates a block diagram of an interleaved analog imaging system with signal conditioning, in accordance with one or more embodiments of the present disclosure.

FIG. 5B shows a simplified schematic of an optical interleaved imaging system with signal conditioning, in accordance with one or more embodiments of the present disclosure.

FIG. 6A depicts a block diagram of an interleaved analog imaging system with a controller, in accordance with one or more embodiments of the present disclosure.

FIG. 6B illustrates a simplified schematic of a photodetector array with a controller, in accordance with one or more embodiments of the present disclosure.

FIG. 7 shows a block diagram of an interleaved analog imaging system with signal conditioning and control, in accordance with one or more embodiments of the present disclosure.

FIG. 8 depicts a block diagram of an interleaved analog imaging system with controlled photonic components, in accordance with one or more embodiments of the present disclosure.

FIG. 9 illustrates a block diagram of an interleaved analog imaging system with optical-to-electrical conversion, in accordance with one or more embodiments of the present disclosure.

FIG. 10 shows a block diagram of an interleaved analog imaging system with photonic processing, in accordance with one or more embodiments of the present disclosure.

FIG. 11 depicts a block diagram of an interleaved analog imaging system with clock generation, in accordance with one or more embodiments of the present disclosure.

FIG. 12 illustrates a flowchart of a method for processing analog electrical signals from photodetector arrays, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing high-speed imaging based on interleaving analog optical signals from one or more photodetector arrays into an interleaved analog optical data signal. This interleaved analog optical data signal may support high-speed, continuous video acquisition/streaming using commercial imagers. For example, embodiments of the present disclosure may support throughputs where optical techniques may be advantageous such as, but not limited to, 1 gigapixel per second, 10 gigapixel per second, 100 gigapixel per second, or higher. However, this is not a limitation. In some cases, the systems and methods disclosed herein may provide advantages at throughput often used with electronic signals (e.g., in a range of 100 megapixel per second to 1 gigapixel per second). As an illustration, the optical techniques disclosed herein may provide superior thermal performance than electronic techniques. Further, interleaving of analog optical signals associated with interleaved imaging channels may minimize gaps between exposures and provide a real-time analog-to-digital conversion and digital signal processing (DSP) pipeline matching the throughput of the interleaved channels.

The systems and methods disclosed herein provide significant advancements in high-speed imaging technology. This innovative system combines analog electrical signal processing with photonic interleaving techniques to achieve continuous, high-framerate imaging capabilities that surpass conventional digital imaging systems. By converting analog electrical signals from photodetector arrays directly into the optical domain and employing sophisticated photonic multiplexing methods, the system overcomes traditional bottlenecks associated with digital conversion, buffering, and data transfer.

The optical interleaved analog imaging system offers several advantages over traditional high-speed imaging technologies. By utilizing photonic components for signal processing and multiplexing, the system can operate at speeds that would be challenging or impossible to achieve with purely electronic systems. The interleaving approach allows for efficient use of multiple analog electrical signals, effectively increasing the overall frame rate beyond what individual photodetector arrays can provide. An optical interleaved signal may be provided as an output signal or processed using any combination of optical or electronic processing techniques. For example, an optical interleaved signal may be processed in real time with a photonic processor, enabling low-latency image analysis and potentially reducing the computational burden on downstream digital systems. As another example, an optical interleaved signal may be digitized for electronic processing.

The components of the interleaved analog imaging system may be fabricated on one or more microchips using various integration approaches. For example, the photodetector arrays, photonic modulators, and photonic multiplexers may be integrated onto a single microchip using monolithic integration techniques, potentially leveraging silicon photonics platforms. Alternatively, the system may employ a heterogenous integration approach, where the photodetector arrays are fabricated on one microchip and the photonic components on another. The electronic components like signal conditioning circuits and controllers may be fabricated on a separate microchip or integrated with other microchips. The choice of integration approach may depend on factors such as desired performance, manufacturing complexity, and cost considerations.

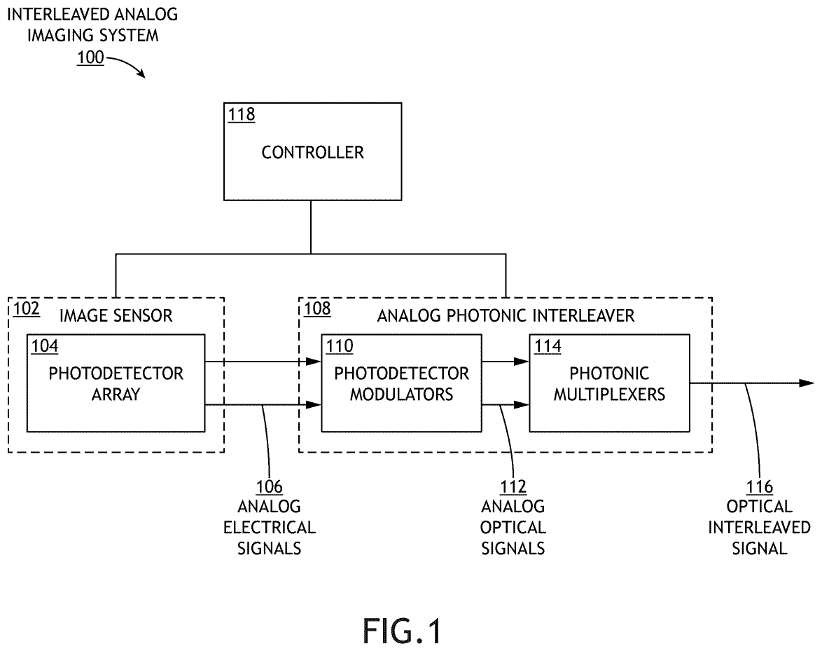

Referring now to FIGS. 1-12, systems and methods providing high-speed imaging using optical interleaving of analog signals is described, in accordance with one or more embodiments of the present disclosure.

FIG. 1 illustrates a block diagram of an interleaved analog imaging system 100, in accordance with one or more embodiments of the present disclosure.

In embodiments, the interleaved analog imaging system 100 includes an image sensor 102 having one or more photodetector arrays 104 that provide multiple analog electrical signals 106.

A photodetector array 104 may include any component or combination of components suitable for generating analog electrical signals 106 based up on incident light. In some cases, a photodetector array 104 is formed as a focal plane array. For example, a photodetector array 104 may be formed as an array of photodiodes. For example, the photodetector array 104 may include a pixel sensor such as, but not limited to, a charge-coupled device (CCD) sensor, a complementary metal-oxide-semiconductor (CMOS) sensor. Further, a photodetector array may be sensitive to electromagnetic radiation in any spectral range including, but not limited to, a visible spectral range, a short-wave infrared (SWIR) spectral range, a mid-wave infrared (MWIR) spectral range, or a long-wave infrared (LWIR) spectral range. In some cases, the photodetector arrays may have different resolutions, sensitivities, or spectral responses to capture complementary image data.

The one or more photodetector arrays 104 may be arranged in any configuration to provide multiple analog electrical signals 106. For example, an image sensor 102 may include different photodetector arrays 104 that each generate a separate analog electrical signal 106. As another example, a particular photodetector array 104 may generate multiple analog electrical signals 106, each associated with a different group of one or more pixels (e.g., photosensitive elements).

Further, the photodetector arrays 104 may be provided in a common housing or separate housings.

In embodiments, the interleaved analog imaging system 100 includes an analog photonic interleaver 108 with one or more photonic modulators 110 to convert the multiple analog electrical signals 106 to analog optical signals 112 and one or more photonic multiplexers 114 to combine the analog optical signals 112 an optical interleaved signal 116.

The photonic modulators 110 may be implemented using any components suitable for converting the analog electrical signals 106 into analog optical signals 112 such as, but not limited to micro-ring resonators, micro-disk resonators, or modulators formed from such components. Further, the photonic modulators 110 may modulate the analog electrical signals 106 at any data rate or duty cycle. In some embodiments, the photonic modulators 110 generate analog optical signals 112 with a shorter duty cycle than the analog electrical signals 106, which may facilitate temporal interleaving by the photonic multiplexers 114. However, this is merely an illustration and not a requirement. The photonic multiplexers 114 may be implemented using any components suitable for interleaving the analog optical signals 112 into a single high-speed optical interleaved signal 116 and may further utilize any multiplexing technique including, but not limited to, temporal multiplexing, wavelength multiplexing, polarization multiplexing, or mode multiplexing.

In embodiments, the interleaved analog imaging system 100 include one or more controllers 118, which may direct or otherwise control the operation of any components including, but not limited to, the image sensor 102, the analog photonic interleaver 108, or any components therein.

The components of the interleaved analog imaging system 100 may work together to achieve high-speed imaging capabilities. The photodetector arrays 104 may capture image data at high speeds, which may be converted to the optical domain by the photonic modulators 110. The photonic multiplexers 114 may then combine these signals, potentially achieving data rates higher than those possible with conventional electronic systems.

In some cases, the optical interleaved signal 116 may be further processed or transmitted for various applications requiring high-speed imaging data. The interleaved analog imaging system 100 may provide a novel approach to high-speed imaging by leveraging the advantages of both analog electrical and optical signal processing techniques.

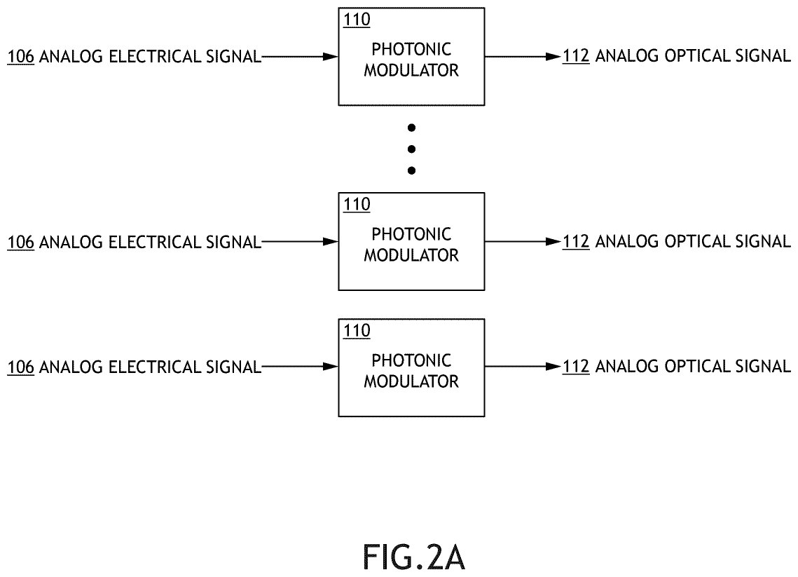

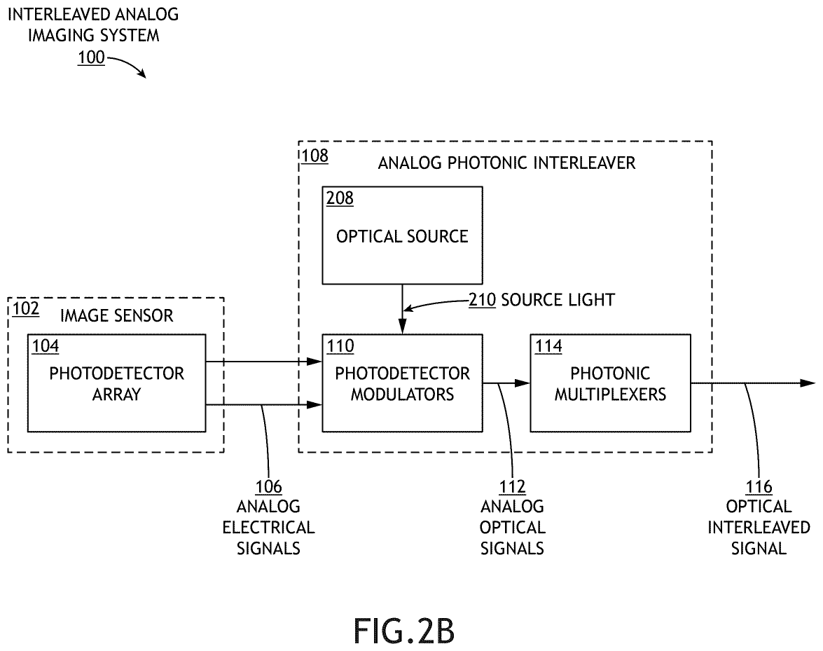

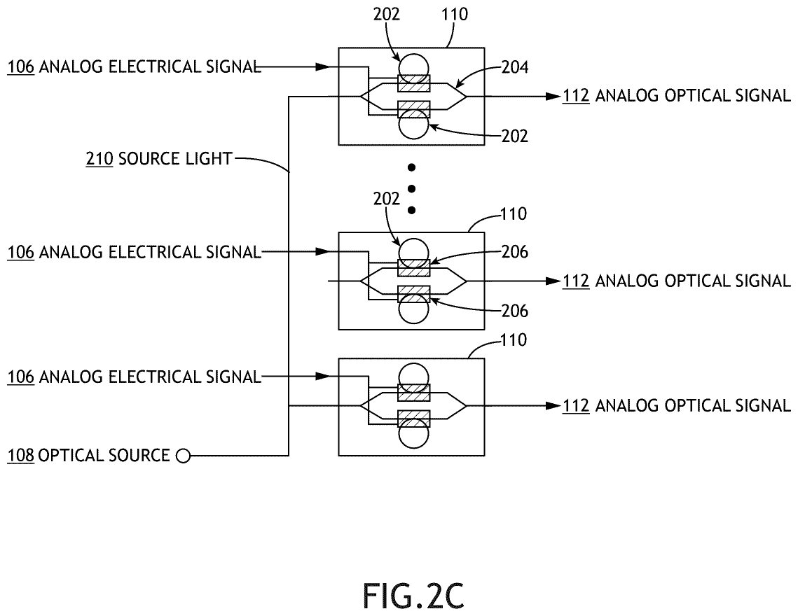

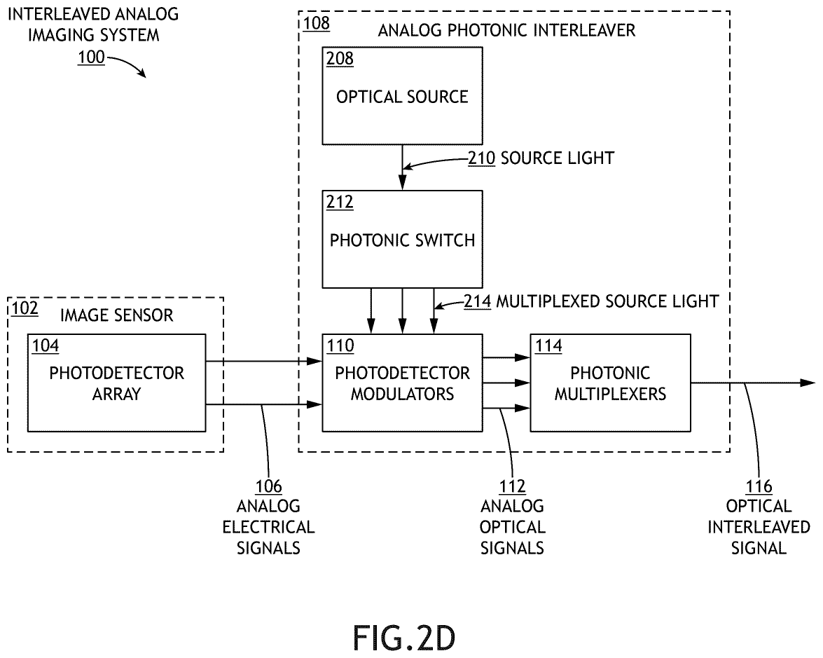

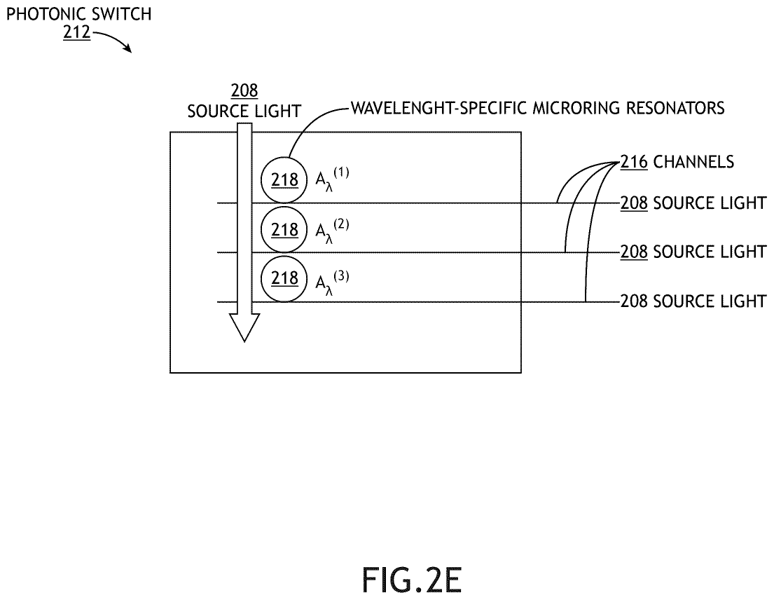

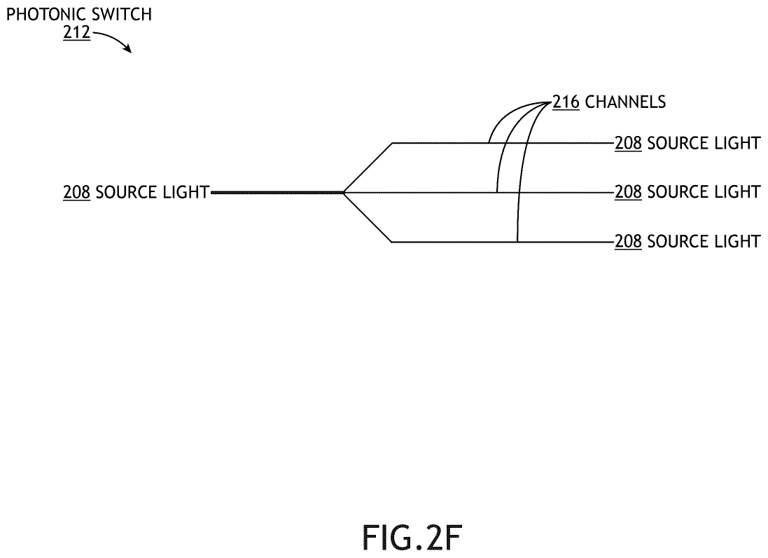

Referring now to FIGS. 2A-2E, the operation of the photonic modulators 110 to convert analog electrical signals 106 to analog optical signals 112 is described in greater detail, in accordance with one or more embodiments of the present disclosure.

FIG. 2A illustrates a block diagram of a series of photonic modulators converting analog electrical signals to analog optical signals, in accordance with one or more embodiments of the present disclosure. The photonic modulators 110 in the interleaved analog imaging system 100 may function to convert multiple analog electrical signals 106 to multiple analog optical signals 112. The photonic modulators 110 may implement any modulation schemes known in the art. For example, the photonic modulators 110 may utilize amplitude modulation, phase modulation, or other modulation techniques to encode the information from the analog electrical signals 106 into analog optical signals 112.

In some embodiments, the one or more photonic modulators 110 operate by modulating source light 208 from an optical source 210. In some embodiments, the optical source 210 is an external component such that the one or more photonic modulators 110 or the analog photonic interleaver 108 more generally may be configured to couple with the external optical source 210 to receive the source light 208. In some embodiments, the optical source 210 is provided as part of the interleaved analog imaging system 100. FIG. 2B illustrates a block diagram of the interleaved analog imaging system 100 in which the analog photonic interleaver 108 includes an optical source 210 to generate source light 208 to be modulated by the one or more photonic modulators 110.

The optical source 210 may include any light source suitable for providing source light 208 for modulation by the one or more photonic modulators 110 such as, but not limited to, a laser source. Further, the optical source 210 may provide source light 208 having any spectrum or wavelength content.

FIG. 2C illustrates a simplified schematic of a portion of an optical interleaved imaging system with photonic modulators 110 providing amplitude-modulated analog optical signals 112, in accordance with one or more embodiments of the present disclosure. In particular, FIG. 2C represents a non-limiting example of the photonic modulators 110 implementing amplitude modulation of source light 208 using Mach-Zender Modulators with pairs of micro-ring or micro-disk resonators 202 arranged in a push-pull interferometer configuration. For example, incoming source light 208 from an optical source 210 may be split into two waveguides 204, each coupled to one of two micro-ring resonators 202 in a pair. The push-pull configuration may involve using two micro-ring resonators 202 with complementary modulation to enhance the overall modulation effect and potentially improve the signal-to-noise ratio of the resulting analog optical signals 112. Further, each micro-ring resonator 202 in the pair may be configured with a phase shifter 206 driven by the analog electrical signals 106, where the phase shifters 206 control the coupling between the micro-ring resonator 202 with adjacent waveguides 204 and ultimately the amplitude of the analog optical signal 112 exiting the Mach-Zender modulator when light in the two waveguides 204 are coupled.

While the embodiment shown in FIG. 2C illustrates the use of micro-ring resonators 202, the interleaved analog imaging system 100 may be implemented with other types of optical modulators. For example, in some cases, the interleaved analog imaging system 100 may utilize bulk optical modulators. In other cases, the interleaved analog imaging system 100 may employ integrated optical modulators of any design fabricated on a semiconductor substrate.

FIGS. 2D-2E illustrate additional modulation schemes. In a general sense, the optical source 210 may generate source light 208 having any properties suitable for modulation. In some embodiments, the optical source 210 generates multiple channels 214 of source light 208, where the source light 208 in any channel 216 may be suitable for modulation by one or more photonic modulators 110. In some embodiments, the analog photonic interleaver 108 includes a photonic switch 212 to provide source light 208 in multiple channels 214 based on input source light 208 from the optical source 210. FIG. 2D illustrates a block diagram of an interleaved analog imaging system 100 including a photonic switch 212 generating source light 208 in three channels 214 for modulation by one or more photonic modulators 110, in accordance with one or more embodiments of the present disclosure.

FIG. 2E illustrates a simplified schematic of a wavelength-multiplexed (e.g., multispectral) photonic switch 212, in accordance with one or more embodiments of the present disclosure. In FIG. 2E, the photonic switch 212 receives multispectral input source light 208 (e.g., from the optical source 210) and provides source light 208 with different wavelengths in each channel 216. Such a configuration may be suitable for, but is not limited to, operation with photonic modulators 110 that implement wavelength multiplexing, where the various analog electrical signals 106 are converted to analog optical signals 112 with different wavelengths by the photonic modulators 110 and combined to a common optical interleaved signal 116 by the one or more photonic multiplexers 114.

FIG. 2E further depicts a particular non-limiting example in which the photonic switch 212 includes multiple wavelength-specific micro-ring resonators 218, each tuned to couple different wavelengths of the multispectral source light 208 into an adjacent waveguide operating as a channel 216.

FIG. 2F illustrates a simplified schematic of a photonic switch 212 in a fanout configuration, in accordance with one or more embodiments of the present disclosure. In FIG. 2F, the photonic switch 212 splits input source light 208 into three different channels 214. Such a configuration may be suitable for, but not limited to, polarization-division or mode-division multiplexing. In these cases, additional components for polarization and/or mode control may be provided in the photonic switch 212 and/or the one or more photonic modulators 110.

Referring generally to FIGS. 2A-2F, it is to be understood that FIGS. 2A-2F and the associated descriptions are provided solely for illustrative purposes and should not be interpreted as limiting. The photonic modulators 110 and any associated or coupled components (e.g., an optical source 210, a photonic switch 212, or the like) may include any components or combination of components suitable for converting analog electrical signals 106 to analog optical signals 112 using any suitable modulation technique.

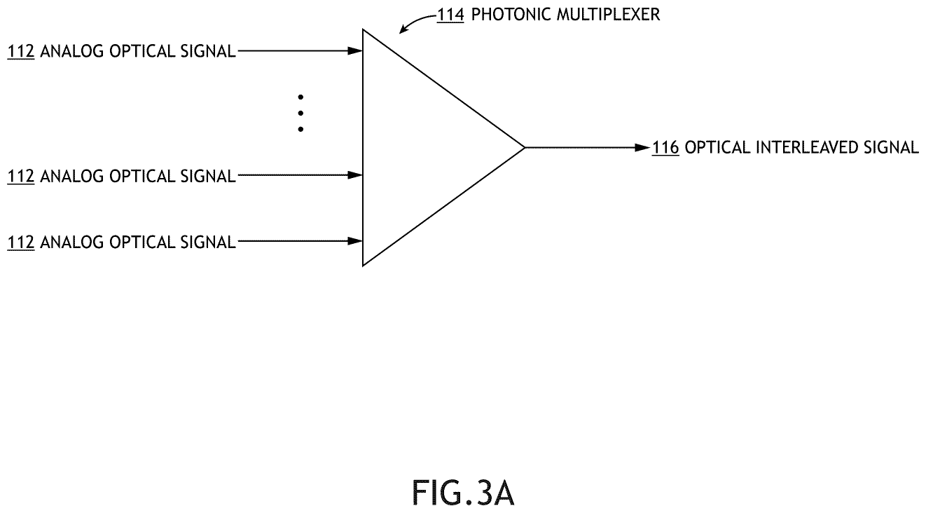

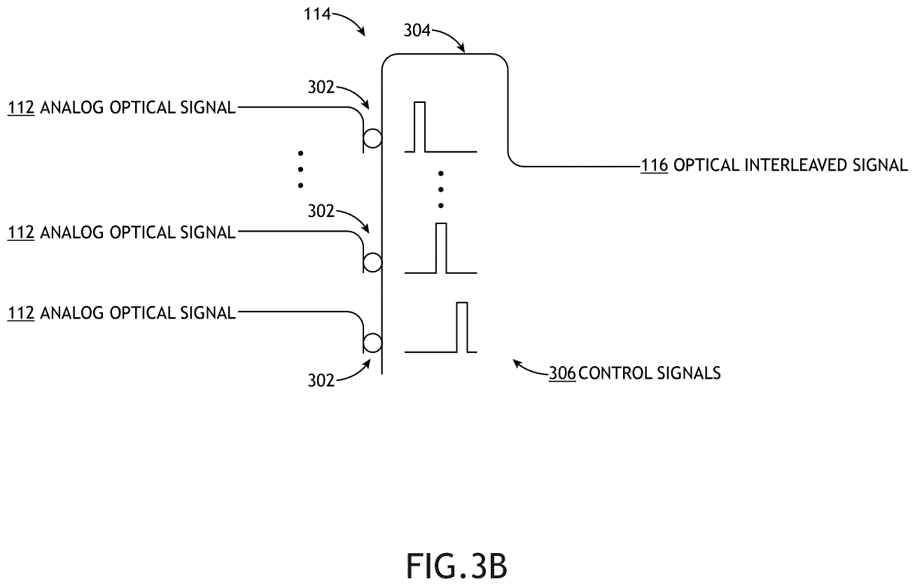

Referring now to FIGS. 3A-3B, the operation of the photonic multiplexers 114 is described in greater detail, in accordance with one or more embodiments of the present disclosure.

FIG. 3A illustrates a block diagram of a photonic multiplexer 114, in accordance with one or more embodiments of the present disclosure. In FIG. 3A, multiple analog optical signals 112 serve as inputs to a photonic multiplexer 114, which combines and interleaves the multiple analog optical signals 112 into a single optical interleaved signal 116. In this way, the analog optical signals 112 are combined by the photonic multiplexer 114 to create the high-bandwidth optical interleaved signal 116 that contains the interleaved data from all the analog optical signals 112.

One or more photonic multiplexers 114 may implement any multiplexing techniques to combine the analog optical signals 112 into the optical interleaved signal 116. In some cases, the photonic multiplexers 114 may be configured to perform time-division multiplexing, which may involve interleaving the analog optical signals 112 in different time slots to create the optical interleaved signal 116. In some cases, the photonic multiplexers 114 may perform polarization-division multiplexing, which may involve combining analog optical signals 112 with different polarization states into the optical interleaved signal 116. In some cases, the photonic multiplexers 114 may implement mode-division multiplexing, which may involve combining analog optical signals 112 in different spatial modes of a waveguide to create the optical interleaved signal 116. In some cases, the photonic multiplexers 114 may be configured to perform wavelength-division multiplexing, which may involve combining analog optical signals 112 at different wavelengths into the optical interleaved signal 116.

FIG. 3B illustrates a schematic of a photonic multiplexer 114, in accordance with one or more embodiments of the present disclosure. In particular, FIG. 3B is a non-limiting example of a photonic multiplexer 114 providing temporal multiplexing. The photonic multiplexer 114 receives multiple analog optical signals 112 as inputs. The analog optical signals 112 are coupled to micro-ring resonators 302 that are further coupled in series to a single waveguide 304. In this configuration, light from the multiple analog optical signals 112 may be sequentially coupled into the single waveguide 304. Further, the timing of the interleaving may be controlled via control signals 306 applied to the micro-ring resonators 302 (e.g., via phase shifters that are not explicitly shown), where the control signals operate to control the coupling of the light from the analog optical signals 112 to the single waveguide 304. For example, the control signals 306 may adjust the resonance conditions of the micro-ring resonators 302 to control when each analog optical signal 112 couples into the waveguide 304. The resulting light from the waveguide is provided as the optical interleaved signal 116. However, it is to be understood that a photonic multiplexer 114 is not limited to micro-ring resonators and may include any component of combination of components suitable for generating an optical interleaved signal 116 from multiple analog optical signals 112. For example, the photonic multiplexer 114 may include or be formed form, but is not limited to, micro-ring resonators, micro-disk resonators, micro-ring modulators, or micro-disk modulators.

The photonic multiplexers 114 may enable the interleaved analog imaging system 100 to combine multiple analog optical signals 112 into a single high-speed optical interleaved signal 116. This capability may allow the interleaved analog imaging system 100 to achieve high data rates and efficient use of optical bandwidth for high-speed imaging applications.

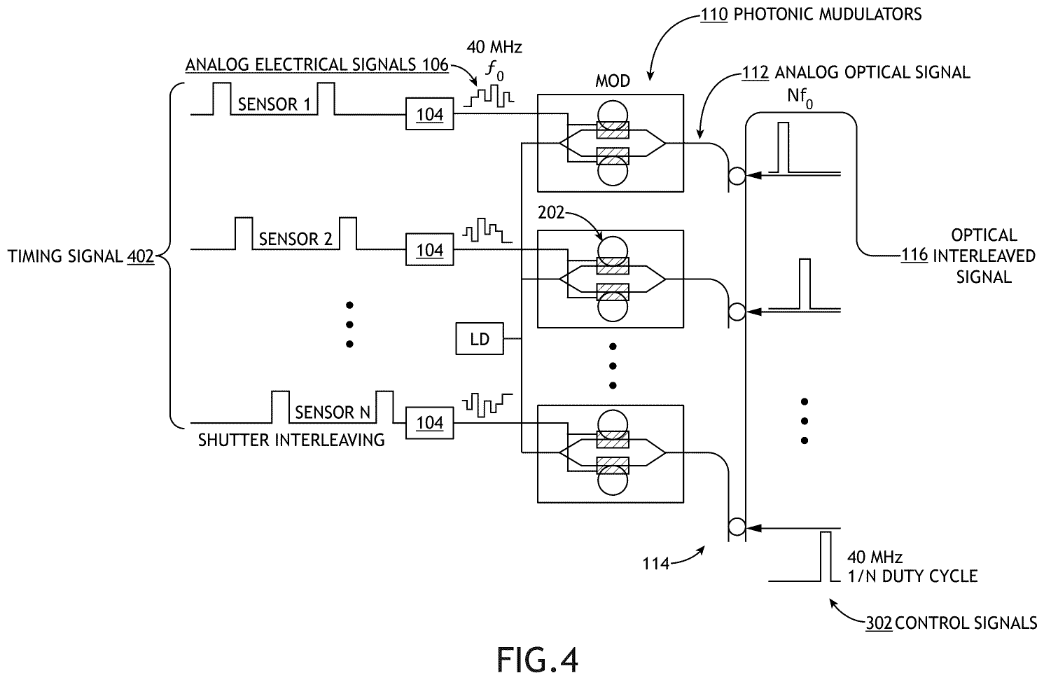

FIG. 4 illustrates a schematic diagram of an interleaved optical imaging system 100 configured to provide time-domain multiplexing of analog electrical signals 106 from multiple different photodetector arrays 104, in accordance with one or more embodiments of the present disclosure. FIG. 4 combines elements from FIG. 2C and FIG. 3B and represents another non-limiting example of temporal interleaving.

In FIG. 4, multiple photodetector arrays 104 may operate at a common repetition rate of f₀ (for example, 40 MHz). The operation of the photodetector arrays 104 may be, but are not required to be, controlled using timing signals 402 that provide shutter interleaving. In some aspects, shutter interleaving may provide non-overlapping exposure windows for the multiple photodetector arrays 104, which involves sequentially triggering the exposure periods such that only one array captures light at any given time. These non-overlapping exposure windows may be arranged to be gapless, with the end of one photodetector array's exposure window precisely coinciding with the start of the next array's exposure window, allowing for continuous light capture across the entire set of photodetector arrays 104.

The analog electrical signals 106 from the photodetector arrays 104 may be provided to the photonic modulators 110, where the photonic modulators 110 convert the analog electrical signals 106 into analog optical signals 112. In some cases, the photonic modulators 110 may generate the analog optical signals 112 with a 1/N duty cycle, where N represents the number of analog optical signals 112 being combined (and thus also the number of analog electrical signals 106). This duty cycle reduction may facilitate the temporal interleaving process.

The analog optical signals 112 from the photonic modulators 110 may then be combined by the photonic multiplexers 114 to generate the optical interleaved signal 116. Due to the interleaving process, the optical interleaved signal 116 may have a bitrate of N·f₀. For example, if four analog electrical signals 106 at 40 MHz are combined, the resulting optical interleaved signal 116 may have a bitrate of 160 MHz.

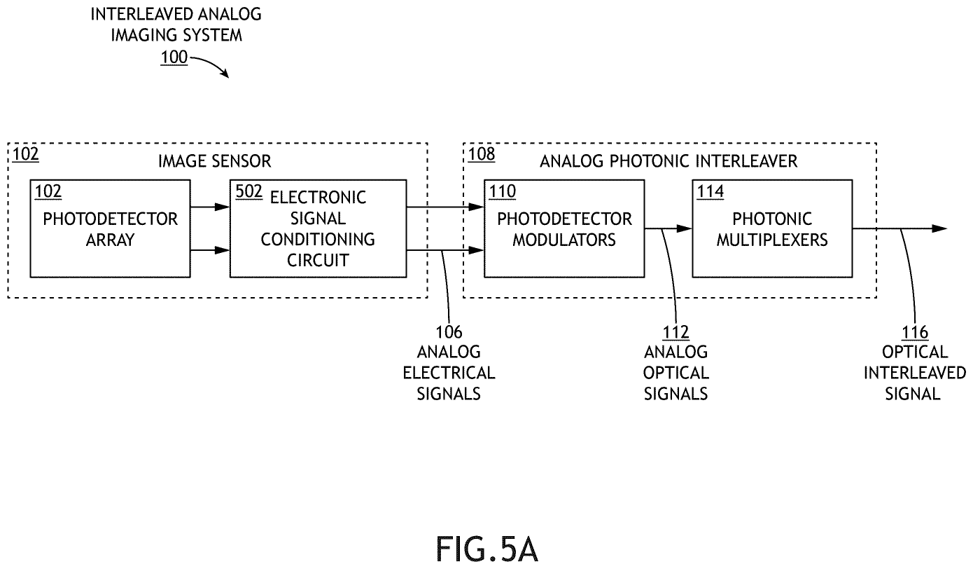

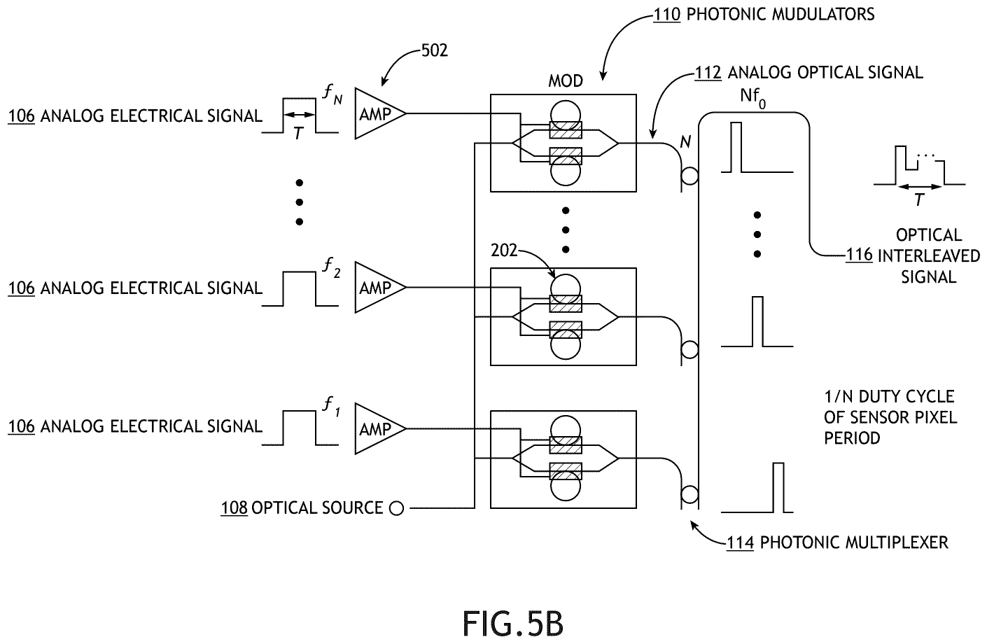

FIG. 5A illustrates a block diagram of an interleaved analog imaging system 100 including an electronic signal conditioning circuit 502, in accordance with one or more embodiments of the present disclosure. FIG. 5A is substantially similar to FIG. 1, but where the image sensor 102 includes an electronic signal conditioning circuit 502 to manipulate the analog electrical signals 106 prior to the analog photonic interleaver 108.

The electronic signal conditioning circuit 502 may include any combination of components suitable for manipulating (e.g., conditioning) the analog electrical signals 106. For example, the electronic signal conditioning circuit 502 may be implemented using various passive or active analog circuit components such as operational amplifiers, filters, and gain stages. In some cases, the electronic signal conditioning circuit 502 may include programmable elements like variable gain amplifier, adjustable filters, or modulators to allow dynamic adaptation of the signal conditioning parameters.

The electronic signal conditioning circuit 502 may condition the analog electrical signals 106 in various ways. For example, the electronic signal conditioning circuit 502 may include one or more amplifiers to adjust the amplitudes of the analog electrical signals 106. As another example, the electronic signal conditioning circuit 502 may filter the analog electrical signals 106 to reduce noise or remove unwanted frequency components. As another example, the electronic signal conditioning circuit 502 may modify the data rate of the analog electrical signals 106. As another example, the electronic signal conditioning circuit 502 may modify the modulation format of the analog electrical signals 106 to prepare them for optical modulation. For instance, the electronic signal conditioning circuit 502 may change a modulation format from an intensity (or amplitude) modulation format provided by a photodetector array 104 to any other format including, but not limited to, a frequency modulation format, a phase modulation format, a pulse-width modulation format, or the like. As another example, the electronic signal conditioning circuit 502 may reduce a number of analog electrical signals 106 by combining two or more analog electrical signals 106.

FIG. 5B illustrates a simplified schematic of an optical interleaved imaging system, in accordance with one or more embodiments of the present disclosure. FIG. 5B incorporates elements from previous figures, including the photonic modulator 110 components from FIG. 2C and the photonic multiplexer 114 components from FIG. 3B. Further, FIG. 5B illustrates a non-limiting example in which the electronic signal conditioning circuit 502 configured as amplifiers.

In the configuration shown in FIG. 5B, the electronic signal conditioning circuit 502 includes amplifiers that amplify the various analog electrical signals 106 before they are provided to the photonic modulators 110. The amplifiers in the electronic signal conditioning circuit 502 may control the amplitudes of the analog electrical signals 106, which may help optimize the signal strength for optical modulation. By amplifying the analog electrical signals 106, the electronic signal conditioning circuit 502 may improve the signal-to-noise ratio and enhance the overall performance of the interleaved analog imaging system 100.

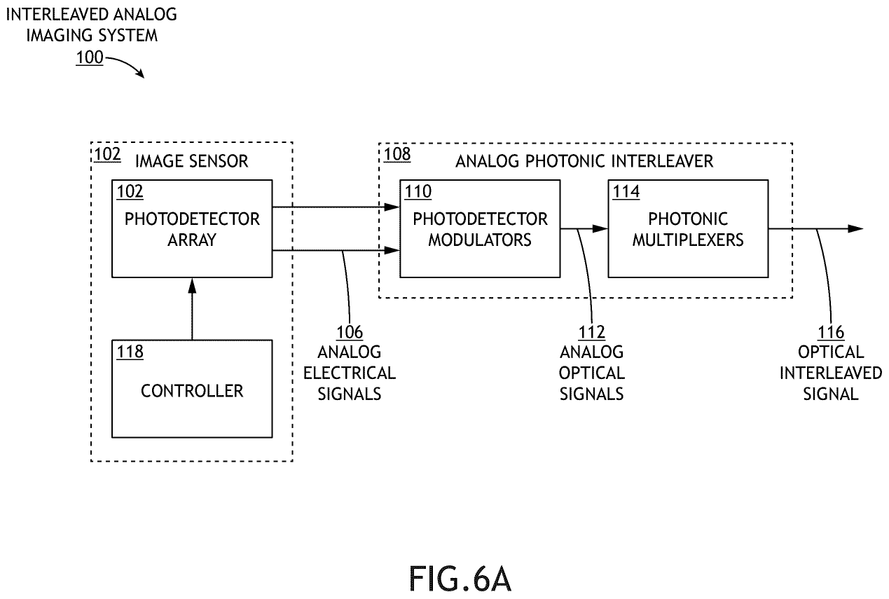

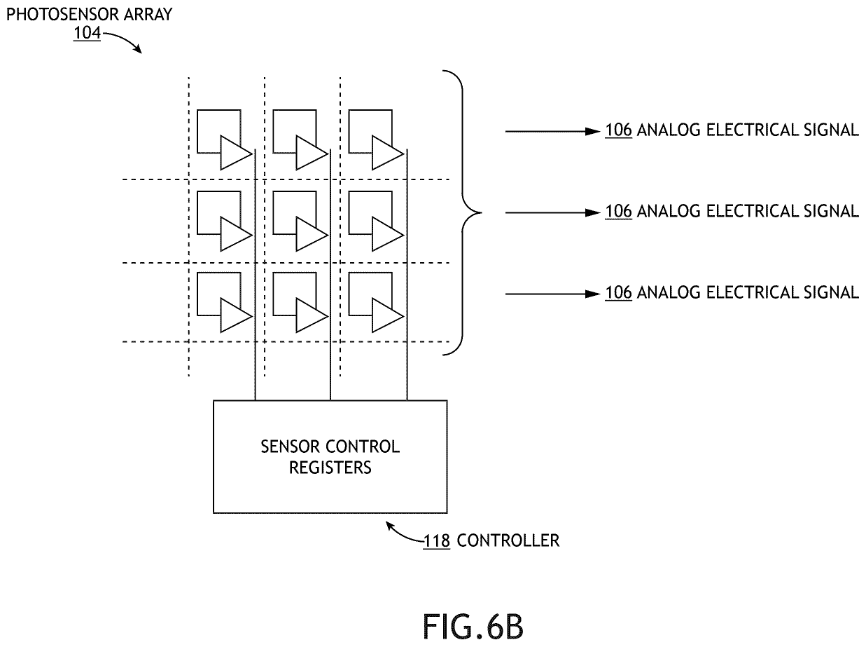

Referring generally to FIGS. 6A-8, the interleaved analog imaging system 100 may include one or more controllers 118 to control any of the constituent components. For example, a controller 118 may generate control signals to manipulate or control any component in the interleaved analog imaging system 100.

The controller may include one or more processors configured to execute program instructions maintained on memory, or memory medium. In this regard, the one or more processors of controller may execute any of the various process steps described throughout the present disclosure. For example, the program instructions may cause the one or more processors to implement and/or direct the implementation of any of the various process steps described throughout the present disclosure.

The one or more processors of a controller may include any processor or processing element known in the art. For the purposes of the present disclosure, the term “processor” or “processing element” may be broadly defined to encompass any device having one or more processing or logic elements such as, but not limited to, one or more micro-processor devices, one or more application specific integrated circuit (ASIC) devices, one or more field programmable gate arrays (FPGAs), one or more digital signal processors (DSPs), one or more central processing units (CPUs), or one or more graphical processing units (GPUs). In this sense, the one or more processors may include any device configured to execute algorithms and/or instructions (e.g., program instructions stored in memory).

The memory may include any storage medium known in the art suitable for storing program instructions executable by the associated one or more processors. For example, the memory may include a non-transitory memory medium. By way of another example, the memory may include, but is not limited to, a read-only memory (ROM), a random-access memory (RAM), a magnetic or optical memory device (e.g., disk), a magnetic tape, a solid-state drive and the like. It is further noted that memory may be housed in a common controller housing with the one or more processors or remotely in a separate housing.

Although the controller 118 is depicted as a single component in FIG. 1, it is contemplated herein that the controller 118 may be distributed between and optionally integrated directly into any of the components of the interleaved analog imaging system 100 including, but not limited to, the image sensor 102 and/or the analog photonic interleaver 108.

FIG. 6A illustrates a block diagram of an interleaved analog imaging system 100 including a controller 118 configured to control a photodetector array 104, in accordance with one or more embodiments of the present disclosure. FIG. 6A is substantially the same as FIG. 1, except for the inclusion of a controller 118 in the image sensor 102.

The controller 118 may control the photodetector array 104 in various ways. For example, the controller 118 may adjust exposure times of individual photodetectors or groups of photodetectors within the array. As another example, the controller 118 may modify gain settings of the photodetector array 104. As another example, the controller 118 may manage readout sequences of the photodetector array 104. As another example, the controller 118 may control the timing of image capture operations. As another example, the controller 118 may adjust sensitivity settings of the photodetector array 104. As another example, the controller 118 may manage power consumption of the photodetector array 104. As another example, the controller 118 may coordinate the operation of multiple photodetector arrays 104 to achieve interleaved imaging.

FIG. 6B illustrates a simplified schematic of the image sensor 102, in accordance with one or more embodiments of the present disclosure. FIG. 6B includes a controller 118 with sensor control registers, where the registers control the operation of the photodetector array 104. The controller 118 may use the sensor control registers to manage the photodetector array 104 in various ways. In some cases, the sensor control registers may store parameters such as integration time for the photodetectors. The sensor control registers may hold binning configurations for combining signals from multiple photodetectors. In some cases, the sensor control registers may store gain settings for different regions of the photodetector array 104.

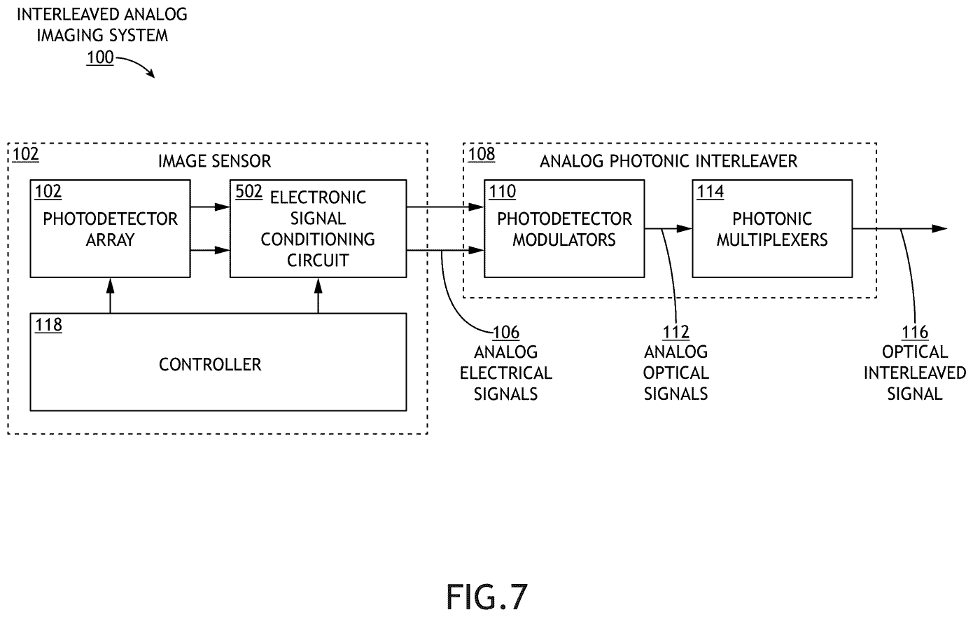

FIG. 7 illustrates a block diagram of an interleaved analog imaging system 100, in accordance with one or more embodiments of the present disclosure. FIG. 7 is substantially the same as FIG. 6A, with the addition that the controller 118 now controls both the photodetector array 104 and an electronic signal conditioning circuit 502.

The controller 118 may control the electronic signal conditioning circuit 502 in various ways. For example, the controller 118 may adjust amplifier gains within the electronic signal conditioning circuit 502. As another example, the controller 118 may modify filter cutoff frequencies of the electronic signal conditioning circuit 502. As another example, the controller 118 may manage the timing of signal processing operations in the electronic signal conditioning circuit 502. As another example, the controller 118 may adjust the modulation format of the analog electrical signals 106 processed by the electronic signal conditioning circuit 502. As another example, the controller 118 may synchronize the operations between the electronic signal conditioning circuit 502 and the photodetector array 104 to ensure proper timing and coordination of signal generation and processing.

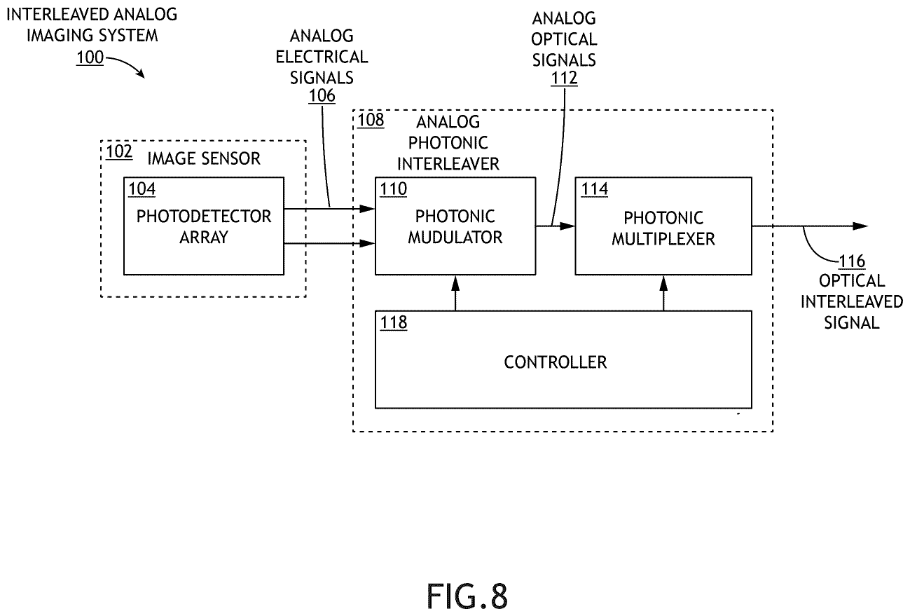

FIG. 8 illustrates a block diagram of an interleaved analog imaging system 100 including a controller 118 configured to control controls the photonic modulators 110 and/or the photonic multiplexers 114, in accordance with one or more embodiments of the present disclosure. FIG. 8 is substantially the same as FIG. 1, except that the analog photonic interleaver 108 includes a controller 118 coupled with the photonic modulators 110 and/or the photonic multiplexers 114.

The controller 118 may control the photonic modulators 110 and/or the photonic multiplexers 114 in various ways. For example, the controller 118 may adjust modulation frequencies of the photonic modulators 110 to adjust the data rate of the analog optical signals 112. As another example, the controller 118 may modify phase relationships between different photonic modulators 110. As another example, the controller 118 may manage switching sequences in the photonic multiplexers 114 to optimize signal interleaving. As another example, the controller 118 may control the timing of modulation and multiplexing operations. For instance, the controller 118 may generate the control signals 306 depicted in FIGS. 3B and 4. As another example, the controller 118 may adjust the coupling strengths of micro-ring resonators 302 in the photonic modulators 110 or photonic multiplexers 114. As another example, the controller 118 may manage the wavelength selection in wavelength-division multiplexing configurations.

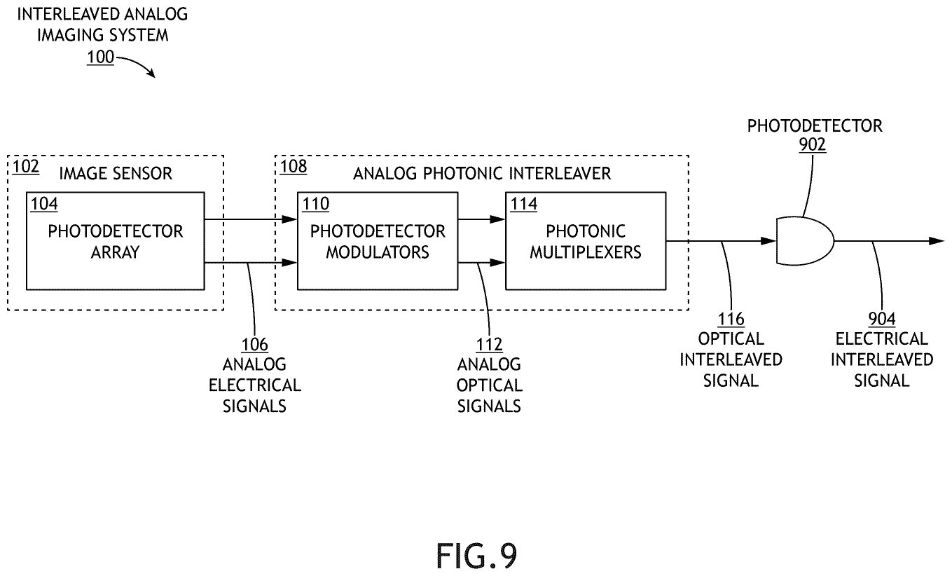

Referring now generally to FIGS. 9-11, the optical interleaved signal 116 generated by the interleaved analog imaging system 100 may be utilized in various ways. In some cases, the optical interleaved signal 116 may be provided as an output for transmission or further processing. In other cases, the optical interleaved signal 116 may be processed using any combination of electrical or optical techniques within the interleaved analog imaging system 100. FIGS. 9-11 illustrate different non-limiting configurations for handling and processing the optical interleaved signal 116.

FIG. 9 illustrates a block diagram of an interleaved analog imaging system 100, in accordance with one or more embodiments of the present disclosure. The interleaved analog imaging system 100 includes an image sensor 102 having a photodetector array 104 that generates analog electrical signals 106. The analog electrical signals 106 are provided to an analog photonic interleaver 108. The analog photonic interleaver 108 includes photonic modulators 110 that convert the analog electrical signals 106 into analog optical signals 112. The photonic modulators 110 provide the analog optical signals 112 to photonic multiplexers 114, which combine and interleave the analog optical signals 112 to generate an optical interleaved signal 116.

FIG. 9 illustrates a block diagram of the interleaved analog imaging system 100 that further includes a photodetector 902 configured to receive the optical interleaved signal 116, in accordance with one or more embodiments of the present disclosure. In FIG. 9, the photodetector 902 may convert the optical interleaved signal 116 into an electrical interleaved signal 904. In some cases, the electrical interleaved signal 904 may be transmitted for further use. In other cases, the electrical interleaved signal 904 may be processed using various electronic techniques.

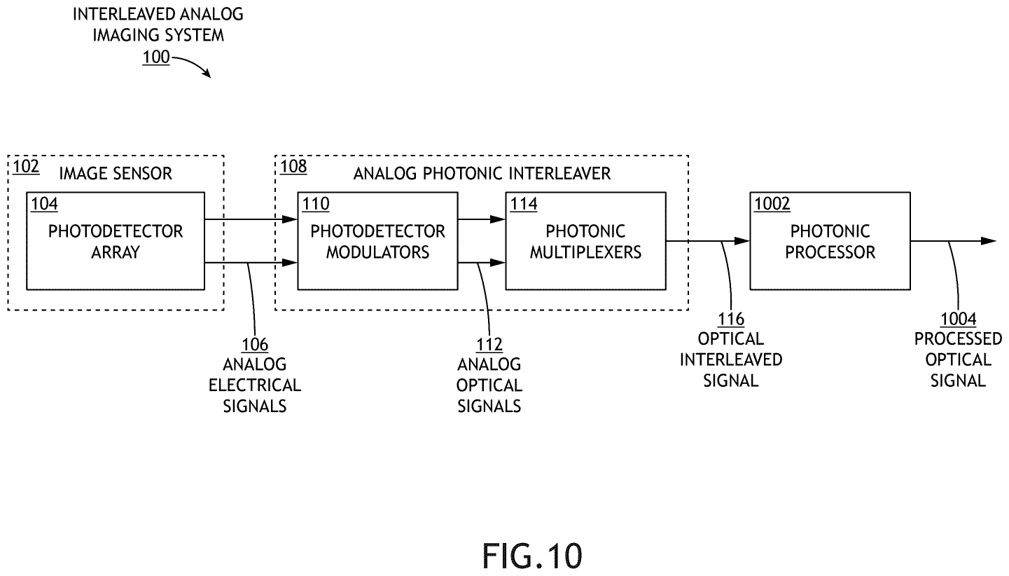

FIG. 10 illustrates a block diagram of the interleaved analog imaging system 100 that further includes a photonic processor 1002, in accordance with one or more embodiments of the present disclosure.

The photonic processor 1002 may perform one or more image processing operations on the optical interleaved signal 116 in the optical domain. For example, the photonic processor 1002 may perform real-time image analysis on the optical interleaved signal 116. As an illustration, the photonic processor 1002 may implement edge detection algorithms, feature extraction, or pattern recognition directly on the optical interleaved signal 116. As another illustration, the photonic processor 1002 may implement sensor non-uniformity correction directly on the optical interleaved signal 116. As another illustration, the photonic processor 1002 may perform image compression or encoding operations. As another illustration, the photonic processor 1002 may implement wavelet transforms or other compression techniques in the optical domain.

As another example, the photonic processor 1002 may perform filtering operations on the optical interleaved signal 116. For instance, the photonic processor 1002 may implement spatial or temporal filters to reduce noise or enhance specific image features. As another example, the photonic processor 1002 may perform color processing or correction on the optical interleaved signal 116. As another example, the photonic processor 1002 may implement machine learning or artificial intelligence algorithms for advanced image analysis or recognition tasks. The photonic processor 1002 may output a processed optical signal 1004 for further use or transmission.

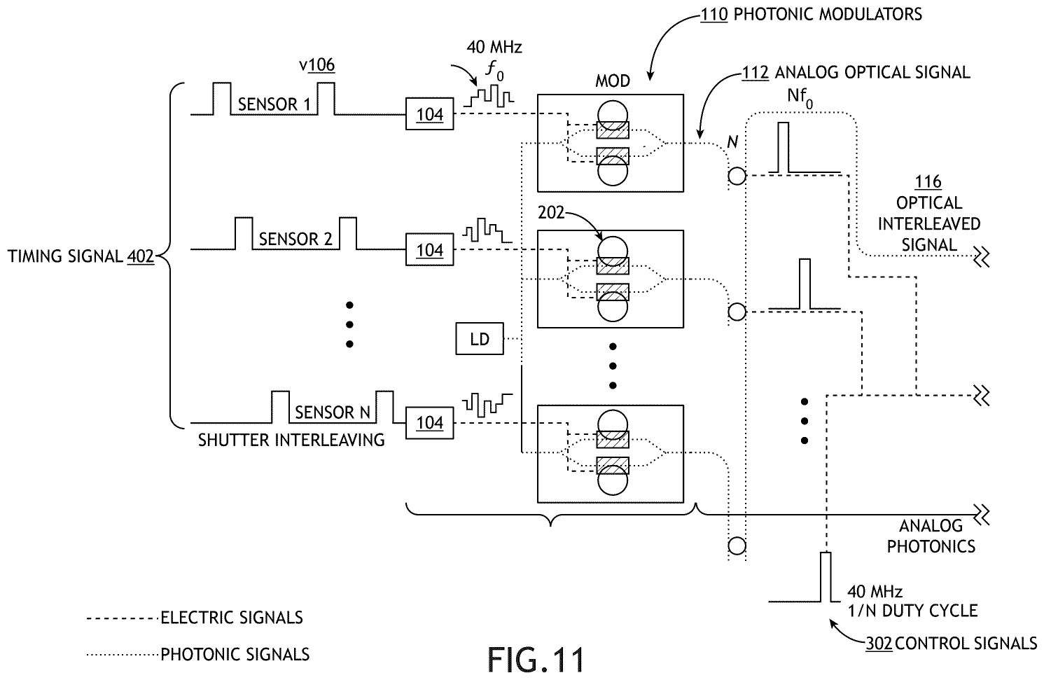

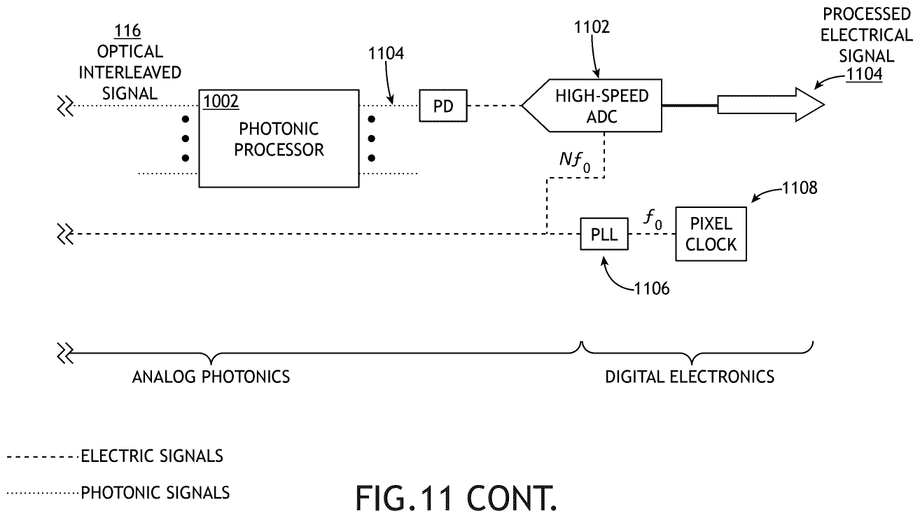

FIG. 11 illustrates a schematic diagram of an interleaved analog imaging system 100, in accordance with one or more embodiments of the present disclosure. FIG. 11 includes all components present in FIG. 4, such as the photodetector arrays 104, photonic modulators 110, and photonic multiplexers 114. Additionally, FIG. 11 introduces several new components to the system.

As described with respect to FIG. 4, FIG. 11 depicts temporal interleaving of data from multiple photodetector arrays 104 into a common optical interleaved signal 116. In this non-limiting example, the analog electrical signals 106 operate at a frequency f₀ (for example, 40 MHz) and are provided to photonic modulators 110, which convert the analog electrical signals 106 into analog optical signals 112 with a 1/N duty cycle at frequency f₀, where N is the number of analog electrical signals 106 being combined. The analog optical signals 112 are combined into an optical interleaved signal 116 having a frequency of N·f₀. It is to be understood that the example of a 40 MHz data rate is merely illustrative and that any data rate is supported. Further, the total throughput of the optical interleaved signal 116 (e.g., N·f₀) may have any suitable value including, but not limited to, 100 megapixel per second, 1 gigapixel per second, 10 gigapixel per second, 100 gigapixel per second, or greater.

FIG. 11 further depicts a configuration in which the optical interleaved signal 116 is provided to a photonic processor 1002 for processing as described with respect to FIG. 10. The processed optical signal 1004 is then directed to a photodetector 902 for conversion to an electrical interleaved signal 904 as described with respect to FIG. 9. This electrical interleaved signal 904 is then directed to an analog-to-digital converter 1102 to generate a processed electrical signal 1104 for transmission or further digital processing.

FIG. 11 further depicts the generation of control signals to synchronize the various components of the interleaved analog imaging system 100. For example, FIG. 11 depicts a clock generator 1108 configured to generate a clock signal at frequency f₀. A phase-locked loop 1106 receives the clock signal from the clock generator 1108, which generates synchronized control signals 306 sent to the photonic modulators 110 at frequency f₀ and additional control signals sent to the analog to digital converter 1102 at frequency N·f₀.

In some cases, the interleaved analog imaging system 100 may include an optical amplifier (not shown) configured to amplify the optical interleaved signal 116 before the optical interleaved signal 116 is provided to the photonic processor 1002 or other components.

The configuration shown in FIG. 11 enables high-speed processing and digitization of the optical interleaved signal 116. The photonic processor 1002 may perform real-time image processing operations on the optical interleaved signal 116, while the analog to digital converter 1102 allows for conversion of the processed optical signal into a digital format for further use or storage. The phase-locked loop 1106 ensures precise timing synchronization between the various components of the system, enabling efficient and accurate processing of the high-speed optical interleaved signal 116 such as, but not limited to, between the photodetector arrays 104 and the analog photonic interleaver 108 or associated components (e.g., the photonic modulators 110 and/or the photonic multiplexers 114).

In some embodiments, the interleaved analog imaging system may include a phase-locked loop configured to synchronize clocks for various components of the system. The phase-locked loop may generate synchronized control signals for the analog photonic interleaver and the photodetector arrays, ensuring precise timing coordination between the optical and electrical domains. This synchronization may enable accurate interleaving of signals from multiple photodetector arrays and proper timing of subsequent optical processing and conversion operations.

However, it is to be understood that FIGS. 9-11 are provided solely for illustrative purposes and should not be interpreted as limiting the scope of the present disclosure. Rather, the optical interleaved signal 116 may be provided directly as an output or processed using any combination of optical or electronic processing techniques in any combination of the optical or electronic domains.

Further, it is contemplated herein that the various components of the interleaved analog imaging system 100 may be provided in any combination of standalone or integrated assemblies. In particular, any combination of the components may be integrated onto common microchips to achieve compact form factors and improved performance.

One integration approach may involve implementing the photodetector array 104 and associated circuitry on a first microchip, while the photonic components are integrated on a separate photonic integrated circuit (PIC) microchip. This heterogeneous integration may allow for optimized fabrication processes for each component type. For example, the photodetector array 104 may be fabricated using a CMOS process optimized for image sensors, while the photonic components may be implemented using a silicon photonics process.

In some implementations, the photonic modulators 110 and photonic multiplexers 114 may be integrated onto a single PIC microchip. This integration may enable efficient coupling between the modulation and multiplexing stages, potentially reducing optical losses and improving overall system performance. The PIC may incorporate waveguides 204, 304, micro-ring resonators 202, 302, and other photonic structures to implement the modulation and multiplexing functions.

Another integration approach may involve monolithic integration of multiple system components onto a single microchip. For instance, the photodetector array 104, electronic signal conditioning circuit 502, and photonic components may be fabricated on a single semiconductor substrate. This high level of integration may be achieved through advanced fabrication techniques such as 3D integration or the use of interposers to connect different functional layers.

In some cases, the controller 118 may be integrated onto the same microchip as other system components. For instance, the controller 118 may be implemented as a digital logic block on the same chip as the electronic signal conditioning circuit 502 and photonic components. This integration may allow for low-latency control of the photonic modulators 110 and photonic multiplexers 114, enabling precise timing and synchronization of the interleaving process.

The photonic processor 1002 may also be integrated onto a microchip, either as part of the PIC containing the photonic modulators 110 and photonic multiplexers 114, or as a separate specialized processor chip. For example, the photonic processor 1002 may be implemented using a combination of photonic and electronic circuits on a single chip, allowing for high-speed optical processing of the optical interleaved signal 116.

In some implementations, the entire interleaved analog imaging system 100, including the photodetector array 104, electronic signal conditioning circuit 502, photonic components, and processing elements, may be integrated onto a single microchip. This high level of integration may be achieved through advanced semiconductor fabrication techniques and careful design of the chip architecture to accommodate both electrical and optical components.

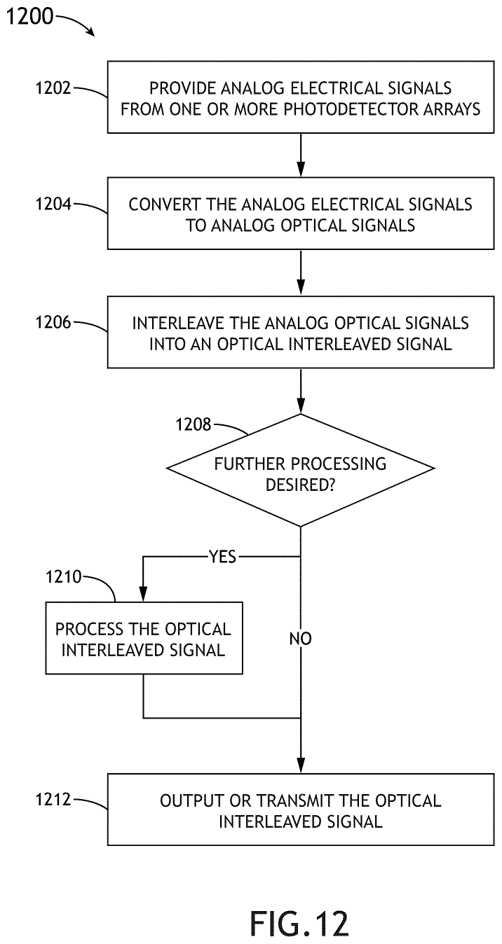

FIG. 12 illustrates a flow diagram of a method for processing analog electrical signals from photodetector arrays to generate an optical interleaved signal, in accordance with one or more embodiments of the present disclosure.

In some embodiments, the method 1200 includes a step 1202, where analog electrical signals are provided from one or more photodetector arrays. For example, in the interleaved analog imaging system 100, this step may involve generating multiple analog electrical signals 106 from one or more photodetector arrays 104 within the image sensor 102. These analog electrical signals 106 may represent image data captured by the photodetector arrays 104.

In some embodiments, the method 1200 includes a step 1204, where the analog electrical signals are converted to analog optical signals. This conversion process transforms the electrical domain signals into corresponding optical domain signals while maintaining their analog nature. In the context of the interleaved analog imaging system 100, this step may be performed by the photonic modulators 110 within the analog photonic interleaver 108. For instance, the photonic modulators 110 may use micro-ring resonators 202 arranged in a push-pull configuration to modulate source light 208 based on the analog electrical signals 106, thereby generating analog optical signals 112.

In some embodiments, the method 1200 includes a step 1206 of interleaving the analog optical signals into an optical interleaved signal. The interleaving combines multiple analog optical signals into a single optical interleaved signal. In the interleaved analog imaging system 100, this step may be carried out by the photonic multiplexers 114. For example, the photonic multiplexers 114 may use techniques such as time-division multiplexing, wavelength-division multiplexing, or mode-division multiplexing to combine the analog optical signals 112 into a single optical interleaved signal 116.

The method 1200 may then move to a decision step 1208, which determines whether further processing is desired. If further processing is desired (Yes branch), the method 1200 may proceed to step 1210, where the optical interleaved signal is processed. In the context of the interleaved analog imaging system 100, this processing step may involve using a photonic processor 1002 to perform various image processing operations on the optical interleaved signal 116. For example, the photonic processor 1002 may implement edge detection algorithms, feature extraction, or pattern recognition directly on the optical interleaved signal 116. After processing at step 1210, the method 1200 returns to step 1208 to determine if additional processing is needed.

If no further processing is desired at step 1208 (No branch), the method 1200 proceeds to step 1212, where the optical interleaved signal is output or transmitted. In the interleaved analog imaging system 100, this step may involve directly transmitting the optical interleaved signal 116 for further use or storage. Alternatively, it may involve converting the optical interleaved signal 116 to an electrical domain using a photodetector 902, or digitizing the signal using an analog-to-digital converter 1102 for subsequent digital processing or storage.

Throughout the method 1200, various control mechanisms may be employed to ensure proper timing and synchronization. For instance, a controller 118 may coordinate the operation of the photodetector arrays 104, photonic modulators 110, and photonic multiplexers 114. Additionally, a phase-locked loop 1106 may be used to synchronize the operation of various components, ensuring precise timing in the generation and processing of the optical interleaved signal. For example, the phase-locked loop 1106 may synchronize a clock for the analog photonic interleaver 108 (e.g., operation of the one or more photonic modulators 110 and/or the photonic multiplexers 114) and the one or more photodetector arrays 104.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. An imaging system comprising:
one or more photodetector arrays providing a plurality of analog electrical signals; and
an analog photonic interleaver comprising:
one or more photonic modulators configured to convert the plurality of analog electrical signals to analog optical signals; and
one or more photonic multiplexers configured to interleave the analog optical signals from the one or more photonic modulators into an optical interleaved signal.

2. The imaging system of claim 1, wherein the one or more photodetector arrays comprise a focal plane array.

3. The imaging system of claim 1, wherein the one or more photodetector arrays are sensitive to at least one of a visible spectral range, a short-wave infrared spectral range, a mid-wave infrared spectral range, or a long-wave infrared spectral range.

4. The imaging system of claim 1, wherein the one or more photonic modulators comprise at least one of micro-ring or micro-disk modulators.

5. The imaging system of claim 4, wherein the at least one of micro-ring or micro-disk modulators are arranged in a push-pull interferometer configuration.

6. The imaging system of claim 1, wherein the one or more photonic multiplexers are configured to perform time-division multiplexing.

7. The imaging system of claim 1, wherein the one or more photonic multiplexers are configured to perform wavelength-division multiplexing.

8. The imaging system of claim 1, wherein the one or more photonic multiplexers are configured to perform polarization-division multiplexing.

9. The imaging system of claim 1, wherein the one or more photonic multiplexers are configured to perform mode-division multiplexing.

10. The imaging system of claim 1, further comprising an optical source configured to provide source light to the one or more photonic modulators.

11. The imaging system of claim 10, wherein the optical source comprises a wavelength-multiplexed laser source.

12. The imaging system of claim 1, further comprising a controller configured to coordinate operation of the one or more photodetector arrays and the analog photonic interleaver.

13. The imaging system of claim 12, wherein the controller is configured to sequentially trigger non-overlapping exposure windows for the one or more photodetector arrays.

14. The imaging system of claim 1, further comprising an electronic signal conditioning circuit configured to condition the plurality of analog electrical signals before they are provided to the one or more photonic modulators.

15. The imaging system of claim 14, wherein the electronic signal conditioning circuit comprises amplifiers configured to control amplitudes of the plurality of analog electrical signals.

16. The imaging system of claim 1, further comprising a photonic switch configured to distribute source light to the one or more photonic modulators.

17. The imaging system of claim 16, wherein the photonic switch comprises at least one of micro-ring resonators or micro-disk resonators arranged in series.

18. The imaging system of claim 1, further comprising a photodetector configured to convert the optical interleaved signal into an electrical interleaved signal.

19. The imaging system of claim 1, further comprising a photonic processor configured to perform at least one of image processing or transmission operations on the optical interleaved signal.

20. The imaging system of claim 1, wherein the one or more photodetector arrays, the one or more photonic modulators, and the one or more photonic multiplexers are integrated on a single microchip.

21. The imaging system of claim 1, wherein the one or more photodetector arrays are on a first microchip and the analog photonic interleaver is on a second microchip.

22. The imaging system of claim 1, further comprising an additional photodetector and an analog-to-digital converter configured to digitize the optical interleaved signal.

23. The imaging system of claim 1, further comprising a phase-locked loop configured to synchronize a clock for the analog photonic interleaver and the one or more photodetector arrays.

24. A method of interleaved analog imaging, comprising:
providing a plurality of analog electrical signals from one or more photodetector arrays;
converting the plurality of analog electrical signals to analog optical signals using one or more photonic modulators; and
interleaving the analog optical signals from the one or more photonic modulators into an optical interleaved signal using one or more photonic multiplexers.

25. The method of claim 24, wherein interleaving the analog optical signals comprises performing at least one of time-division multiplexing, wavelength-division multiplexing, polarization-division multiplexing, or mode-division multiplexing.

26. The method of claim 24, further comprising coordinating operation of the one or more photodetector arrays and at least one of the one or more photonic modulators or the one or more photonic multiplexers using a controller.

27. The method of claim 24, further comprising conditioning the plurality of analog electrical signals before converting them to the analog optical signals.

28. The method of claim 27, wherein conditioning the plurality of analog electrical signals comprises controlling amplitudes of the plurality of analog electrical signals using amplifiers.

29. The method of claim 24, further comprising distributing source light to the one or more photonic modulators using a photonic switch.

30. The method of claim 24, further comprising converting the optical interleaved signal into an electrical interleaved signal using a photodetector.

31. The method of claim 24, further comprising performing one or more image processing operations on the optical interleaved signal using a photonic processor.
